(19) United States
(12) Patent Application Publication
(10) Pub. No.: US 2013/0127701 A1
(43) Pub. Date: May 23, 2013

(54) DISPLAY APPARATUS AND POWER SUPPLY METHOD THEREOF

(71) Applicants: Eun-il CHO, Suwon-si (KR); Kang-hyun YI, Yesan-gun (KR)

(72) Inventors: Eun-il CHO, Suwon-si (KR); Kang-hyun YI, Yesan-gun (KR)

(73) Assignee: SAMSUNG ELECTRONICS CO., LTD., Suwon-si (KR)

(21) Appl. No.: 13/611,150

(22) Filed: Sep. 12, 2012

(30) Foreign Application Priority Data
Nov. 22, 2011 (KR) 10-2011-0122505

(51) Int. Cl. G09G 3/36

(52) U.S. Cl. 345/102

(57) ABSTRACT

A display apparatus includes a power supply unit which supplies power to the display apparatus, a secondary battery which is charged from the supplied power, a backlight driving unit which drives a backlight of the display apparatus using at least one of the power of the power supply unit and the power charged in the secondary battery, A control unit controls power supplied to the backlight and a charging operation of the secondary battery based on a predetermined power consumption level. The secondary battery charges when there is power left over, and discharges to brighten the backlight when a power level demanded exceeds the predetermined power consumption level.

### CROSS-REFERENCE TO RELATED APPLICATIONS

This application claims priority from Korean Patent Application No. 2011-0122505, filed in the Korean Intellectual Property Office on Nov. 22, 2011, the entire disclosure of which is incorporated herein by reference.

### BACKGROUND

1. Field

Methods and apparatuses consistent with the exemplary embodiments relate to a display apparatus and power supplying method thereof, and more particularly, to a display apparatus which provides a bright screen while complying with a predetermined power consumption level, and a power supplying method thereof.

2. Description of the related art

Conserving energy is an important focus in the modern world. Thus, in the home appliance field, power consumption has become a criterion for evaluating performance. The United States and Europe have set regulations that govern the granting of power consumption ratings to each electronic apparatus, and when Energy Star takes effect in May 2012, the operating power consumption for TVs of 50 inches or more will be limited to 108 W.

In view of the continuing need to reduce power consumption, the focus of many regulations and efforts has been on reducing the power consumption in backlights of LED and LCD TVs, since the most power is consumed in the backlights.

So far, power consumption in the backlights is being reduced mostly by attempts at raising efficiency, through high efficiency LEDs and circuits, but this approach has yet to make any substantial headway, and thus the actual reduction of the brightness of backlights is being carried out.

In general, conventional LED and LCD TVs include an output power supply unit, an image processing unit for processing signals, and a backlight driving unit for driving a backlight. However, since such LED and LCD TVs do not emit their own light (i.e., are not “self-light emitting devices”), the brightness of the TV is determined 100% by the brightness of the backlight. Therefore, in order to increase the brightness, the power provided from the backlight driving unit to the backlight unit must be increased further. That is, for a brighter TV, more power must be provided to raise the brightness of the backlight to, in turn, raise the brightness of the TV.

Raising the brightness of such TVs, without consuming more power, would theoretically be possible by adding a new backlight light source which could emit more light per watt, but this approach is difficult to apply to the commercial market because of technology and expense factors.

Table 1, below, illustrates the Energy Star list which is part of an international program by the United States government. The program encourages consumers to use energy-saving consumer products. The Energy Star logo is now well known, and consumers are familiar with Energy Star ratings which can be found in numerous computer products and peripheral devices.

TABLE 1

| Inch | v3.0(present) | V4.0(May, 2011) | V5.0(May, 2012) |
|---|---|---|---|
| 40 | 192 | 108 | 75 |
| 42 | 212 | 117 | 82 |
| 46 | 243 | 133 | 93 |
| 50 | 317 | 153 | 108 |
| 52 | 333 | 165 | 108 |
| 55 | 351 | 179 | 108 |
| 56 | 360 | 186 | 108 |
| 57 | 367 | 191 | 108 |
| 58 | 375 | 197 | 108 |
| 61 | 391 | 210 | 108 |
| 63 | 414 | 227 | 108 |

With reference to the above table, in the case of the US market, when Energy Star 5.0 takes effect, the power consumption for operating a 46 inch TV will be limited to 93 W. That is, unless a new type of backlight light source is developed, the only way to reduce power consumption would appear to be by reducing the actual brightness of the backlighting. That is, bright TVs may be unable to obtain the Energy Star 5.0 rating.

### SUMMARY

An aspect of the exemplary embodiments relates to a display apparatus which provides a brighter screen while complying with a predetermined power consumption level, and a method of supplying power thereof.

According to an exemplary embodiment, a display apparatus may include a power supply unit which supplies power to the display apparatus, a secondary battery which is charged using power supplied from the power supply unit, a backlight driving unit which drives a backlight of the display apparatus using at least one of the power supplied from the power supply unit and power discharged from the secondary battery, and a control unit which controls the supply of power to the backlight, and controls a charging operation of the secondary battery, based on a predetermined power consumption level.

In addition, the control unit may control the backlight driving unit so that the power supplied from the power supply unit and the power discharged from the secondary battery are both supplied to the backlight when a present power consumption level of the display apparatus is greater than the predetermined power consumption level, and control the backlight driving unit so that only the power supplied from the power supply unit is supplied to the backlight when the power consumption level of the display apparatus is less than the predetermined power consumption level.

Furthermore, the control unit may suspend charging the secondary battery when the power consumption level of the display apparatus is greater than the predetermined power consumption level, and enable the charging of the secondary battery using the power of the power supply unit when the power consumption of the display apparatus is smaller than the predetermined power consumption.

In addition, when the power consumption level of the display apparatus is less than the predetermined power consumption level, the control unit may enable the charging of the secondary battery taking into account a difference between the power consumption level of the display apparatus and the predetermined power consumption level.

In addition, the control unit may detect a charged state of the secondary battery, and when the control unit detects that the secondary battery is fully charged, the control unit may suspend the charging of the secondary battery.

Furthermore, the control unit may control the power supply unit so that the power supply unit supplies power at a level corresponding to the predetermined power consumption level.

In addition, the control unit may determine the level of the power consumption of the display apparatus based on a brightness of the backlight.

Furthermore, the control unit may control an output impedance of the power supply unit based on a state of the charging operation of the secondary battery and on a state of the driving operation of the backlight.

The display apparatus may further include an energy converting unit which converts renewable energy into electrical energy; and wherein the secondary battery is charged using the converted renewable energy.

According to an exemplary embodiment of the present disclosure, a power supply method of a display apparatus may include supplying power to the display apparatus, based on a predetermined power consumption level, making a determination as to a level of power to supply to a backlight of the display apparatus and a level of power to use to charge a secondary battery, charging the supplied power to the secondary battery according to the result of the determination, and driving the backlight of the display apparatus using at least one of the supplied power and power discharged from the secondary battery, according to the result of the determination

In addition, the driving may include supplying the power from the power supply unit and power discharged from the secondary battery to the backlight when the power consumption level of the display apparatus is greater than the predetermined power consumption level, and supplying only the power from the power supply unit to the backlight when the power consumption level of the display apparatus is less than the predetermined power consumption level.

Furthermore, the charging of the secondary battery may be suspended when the power consumption level of the display apparatus is greater than the predetermined power consumption level, and enabling the charging of the secondary battery when the power consumption level of the display apparatus is less than the predetermined power consumption level.

When the power consumption level of the display apparatus is less than the predetermined power consumption level, the charging of the secondary battery may be carried out taking into account a difference between the power consumption level of the display apparatus and the predetermined power consumption level.

In addition, the power supply method may further include detecting a charged state of the secondary battery, and may suspend the charging operation when the secondary battery is fully charged.

Furthermore, a charged state of the secondary battery may be detected, and when the detection indicates that the secondary battery is fully charged, the charging of the secondary battery may be suspended.

The power supply method may further include determining the level of the power consumption of the display apparatus based on a brightness of the backlight.

In addition, the power supply method may further include supplying power by controlling an output impedance taking into account a state of the charging operation of the secondary battery and a state of the driving of the backlight.

In addition, the display apparatus may further include converting renewable energy into electrical energy, and the secondary battery may charge using the converted renewable energy.

In another exemplary embodiment, a display apparatus may include a power supply and a secondary battery controlled by a controller, a backlight connected to receive power from the power supply and the secondary battery, the controller may regulate a power consumption level of the display apparatus based on a power consumption level goal. When a current power consumption level is less than the goal level, the controller may enable charging of the secondary battery, and when a requested power consumption level is not less than the goal level, the controller may enable the secondary battery to supply power to the backlight.

In addition, the controller may suspend charging of the secondary battery in response to an indication that the secondary battery is fully charged.

Also, the controller may enable charging of the secondary battery at a level taking into account a difference between the goal level and the current power consumption level.

Moreover, the controller may permit charging of the secondary battery when the current power consumption level is not less than the goal level.

### BRIEF DESCRIPTION OF THE DRAWINGS

The above and/or other aspects of the present disclosure will be more apparent by describing certain present disclosure with reference to the accompanying drawings, in which:

FIG. 1 is a block diagram illustrating a display apparatus according to an exemplary embodiment;

FIG. 2 is a graph illustrating power supplied to a backlight;

FIG. 3 is a graph illustrating a method for charging a secondary battery with supplied power;

FIG. 4 is a block diagram illustrating a power distributing method;

FIG. 5 is a graph explaining the power distributing method according to FIG. 4;

FIG. 6 is a block diagram illustrating a display apparatus according to another exemplary embodiment; and

FIG. 7 is a flowchart explaining a power supply method of a display apparatus according to an exemplary embodiment.

### DETAILED DESCRIPTION

Certain exemplary embodiments are described in detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without such specifically defined matters. Also, well-known functions or constructions are not described in detail since they would obscure the application with unnecessary detail.

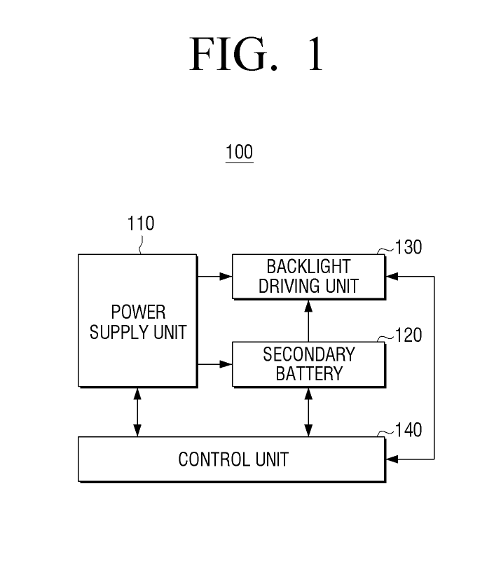

FIG. 1 is a block diagram illustrating a display apparatus according to an exemplary embodiment. With reference to FIG. 1, the display apparatus 100 includes a power supply unit 110, a secondary battery 120, a backlight driving unit 130, and a control unit 140 (also referred to as a “controller”). Herein, the display apparatus 100 is an apparatus which outputs data visually, and may be embodied as a CRT (cathode ray tube), LCD (Liquid Crystal Display), PDP (Plasma Display Panel), LED (Light Emitting Diode), or OLED (Organic Light Emitting Diode). However, in the scenario discussed above, the display apparatus 100 may be an LCD display apparatus or an LED display apparatus having a backlight unit.

The power supply unit 110 supplies power to the display apparatus 100.

More specifically, the power supply unit 110 may supply power to each constituent forming the display apparatus 100. That is, according to FIG. 1, the power supply unit 110 may supply power to the secondary battery 120, the backlight driving unit 130, and the control unit 140.

In addition, the power supply unit 110 may supply power corresponding to a predetermined power consumption level (i.e., a goal level), in accordance with control performed by the control unit 140, to be explained hereinafter. That is, with reference to the aforementioned table 1, in the case of the US market, when Energy Star 5.0 takes effect, the Energy Star power consumption limit for operating a 46 inch TV will be 93 W. That is, in order to comply with the Energy Star standards of table 1, the operating power consumption of a 46 inch TV may be no more than 93 W, in which case the power supply unit 110 may generate power corresponding to the predetermined power consumption level 93 W according, under control of the control unit 140 to be explained hereinafter.

Herein, the power supply unit 110 may be embodied, for example, as a Switched-Mode Power Supply (SMPS). Herein, the SMPS may be constituted by an AC-DC Converter area and a DC-DC Converter area. That is, the SMPS may convert AC voltage input at 110V or 220V into a DC voltage, and then change it to a different DC voltage according to the IC corresponding to each apparatus.

The secondary battery 120 refers to a battery which can be repeatedly used through a process of discharging, where chemical energy is converted into electric energy, and a process of charging, where the electric energy is converted into chemical energy.

The secondary battery 120 may include a charging circuit for charging the secondary battery 120. That is, in order to charge the secondary battery 120, there may be an additional secondary battery 120 charging circuit. For the purposes of the explanation below, it will be assumed that the secondary battery 120 includes a charging circuit.

In addition, a determination as to whether or not to charge the secondary battery 120 may be made based on (i.e., taking into account) the power consumption of the display apparatus 100.

In addition, the control unit 140 may cause the power stored in the secondary battery 120, through charging, may be supplied to the backlight driving unit, also based on the power consumption of the display apparatus 100.

Whether or not to charge the secondary battery 120 may also be determined according to a charged state of the secondary battery 120.

The secondary battery 120 may concretely be embodied as a nickel cadmium battery, nickel hydrogen battery, lithium ion battery, or lithium ion polymer battery.

In an alternative embodiment, the secondary battery 120 may be embodied as a super capacitor. Herein, the super capacitor electrically has the same function as a battery charger, which could gather power and discharge electricity as necessary.

The backlight driving unit 130 drives the backlight of the display apparatus 100.

Specifically, the backlight driving unit 130 may drive the backlight of the display apparatus 100 using the power output by the power supply unit 110, the power charged in the secondary battery 120, or both. That is, when the display apparatus 100 includes an LCD display apparatus or an LED display apparatus, an additional backlight unit is necessary, and thus the backlight driving unit 130 may drive the backlight of the display apparatus 100 using the power of the power supply unit 110, the power charged in the secondary battery 120, or both.

Herein, the backlight driving unit 130 may be embodied as a backlight driving circuit, including a backlight driving circuit already well known.

The control unit 140 controls the overall function of the display apparatus 100. That is, the control unit 140 may control the power supply unit 110, the secondary battery 120, and the backlight driving unit 130.

In addition, the control unit 140 may control the power supply unit so that power corresponding to the level of a predetermined power consumption is generated.

That is, with reference to the aforementioned table 1, in the case of the US market, when Energy Star 5.0 takes effect, the power consumption for operating a 46 inch TV will be limited to 93 W. In this example, the predetermined size of the power consumption may then be set at 93 W. Then, the control unit 140 may predetermine the power consumption to be 93 W so as to comply with the Energy Star standards of table 1, and control the power supply unit 110 so as to continuously generate power corresponding to the predetermined power consumption level of 93 W. Accordingly, the display apparatus 100 can consume the power corresponding to the standards of the aforementioned table 1.

Furthermore, if the power consumption (i.e., the present or current power consumption level) of the display apparatus 100 is detected to be greater than the predetermined power consumption level, the control unit 140 controls the secondary battery 120 so that a charging operation is suspended, and if the power consumption of the display apparatus 100 is smaller than the predetermined power consumption level, the control unit 140 may control the secondary battery 120 so that a charging operation is enabled, using the power output by the power supply unit 110. In this case, if the power consumption of the display apparatus 100 is smaller than the predetermined power consumption level, the control unit 140 may control the secondary battery so that the charging operation is performed, to the extent that there is a difference between the power consumption of the display apparatus 100 and the predetermined power consumption level.

With reference to the aforementioned table 1, an assumption has been made that the TV is 46 inches and the control unit 140 predetermined the power consumption as 93 W, in order to comply with the Energy Star standards of table 1. That is, the control unit 140 exerts control so that the power supply unit 110 continuously supplies the predetermined power consumption level of 93 W, and thus in this case, if the power consumption of the display apparatus 100 is 43 W, 50 W power may be left over. In such a situation, the control unit 110 may exert control so that the secondary battery 120 is charged with the leftover power. By doing this, the secondary battery 120 may be charged with the leftover power, and when the leftover power is greater than the predetermined power consumption level of the display apparatus 100, the secondary battery 100 may supply the leftover power to the backlight driving unit 130.

In addition, the control unit 140 may detect the charged state of the secondary battery 120, and when it is determined that the secondary battery 120 is fully charged, the control unit 140 may control the secondary battery 120 not to perform a charging operation.

That is, if the secondary battery 120 is fully charged, further charging is meaningless, and thus the secondary battery 120 may be controlled so as not to perform a charging operation.

In addition, in a situation in which the secondary battery 120 is fully charged, the control unit 140 may carry out control so that the power supply unit 110 does not continuously supply the power at a level corresponding to the predetermined power consumption level. That is, if the secondary battery 120 is fully charged, the control unit 140 may reduce the power consumption of the display apparatus 100 by carrying out control operations so that only the power corresponding to the power consumption of the display apparatus is supplied. For example, in the case where the current power consumption of the display apparatus 100 is 43 W and the secondary battery 120 is fully charged, the control unit 140 may control the power supply unit 110 to generate only the power corresponding to the current power consumption 43 W.

In addition, the control unit 140 may control both the power supplied to the backlight of the display apparatus 100, and also the charging operation of the secondary battery, based on the predetermined power consumption level. Specifically, if the power consumption of the display apparatus 100 is greater than the predetermined power consumption level, the control unit 140 may carry out control operations with respect to the backlight driving unit 130 so that the power of the power supply unit 110 and also the power charged in the secondary battery 120 are supplied to the backlight, and if the power consumption of the display apparatus is smaller than the predetermined power consumption level, only the power of the power supply unit 110 is supplied to the backlight.

With reference to the aforementioned table 1, an assumption has been made that the TV is 46 inches, and the power consumption of the control unit 140 is predetermined so as to be 93 W in order to comply with the Energy Star standards. In this case, the control unit 140 may control the power supply unit 110 to generate power corresponding to the predetermined power consumption level of 93 W. However, since neither an LED or LCD TV is a self-light emitting apparatus, the brightness of the TV is determined completely by the backlight. Therefore, in order to increase the brightness, it is necessary to further increase the power supplied from the backlight driving unit to the backlight. That is, more power must be supplied to raise the brightness of the backlight in order to increase the brightness of the TV. However, in the case where the power supply unit 110 generates only the power corresponding to the predetermined power consumption level of 93 W, the power supplied to the backlight cannot exceed the predetermined power consumption level of 93 W, and thus it is not possible to achieve a level of brightness which exceeds a certain brightness. Therefore, if the control unit 140 detects that the power consumption of the display apparatus 100 is greater than the predetermined power consumption level of the display apparatus 100, the control unit 140 according to an exemplary embodiment carries out control operations with respect to the backlight driving unit 130 so that the power of the power supply unit 110 and the power charged in the secondary battery 120 are both supplied to the backlight, and if the power consumption of the display apparatus 100 is smaller than the predetermined power consumption level, the display apparatus 100 according to an exemplary embodiment controls the backlight driving unit 130 so that only the power from the power supply unit 110 is supplied to the backlight. Thus, it is possible to achieve a comparatively brighter TV even while ensuring that the power consumption of the display apparatus 100 does not exceed the predetermined power consumption level.

In addition, the control unit 140 may determine the amount of power consumption of the display apparatus 100 based on the brightness of the backlight. That is, the most power consumption in the case of LED TVs and LCD TVs is in the backlight. Therefore, the control unit 140 may determine the size of the power consumption of the display apparatus 100 based on the brightness of the backlight.

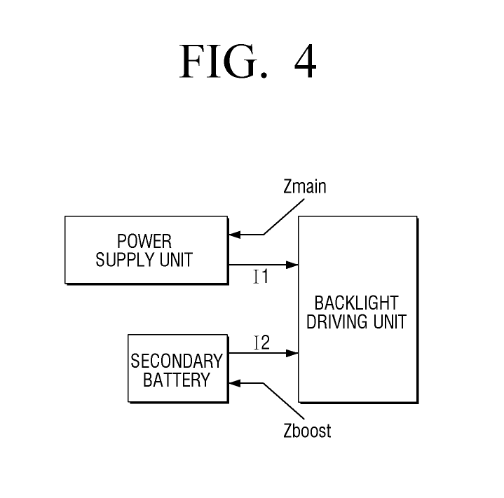

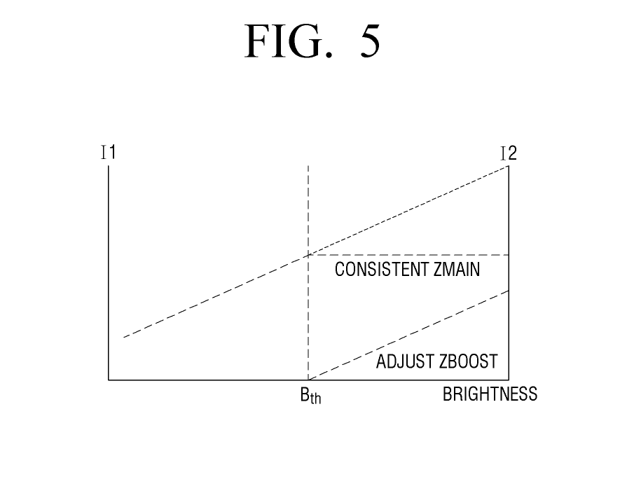

In addition, the control unit 140 may control the output impedance of the power supply unit 110 according to the charging operation of the secondary battery and the driving operation of the backlight. This will be explained in more detail with reference to FIGS. 4 and 5.

Herein, the control unit 140 may include a CPU, a ROM where a control program is stored, and a RAM which stores input data or is used as an area where data related to operations is stored. Herein, the CPU, ROM, and RAM may be mutually connected through an internal BUS or the like.

In addition, more preferably, if the power consumption of the display apparatus 100 is smaller than the predetermined power consumption level, the power consumption of the display apparatus 100 may be the same or smaller than the predetermined power consumption level. And more preferably, if the power consumption of the display apparatus 100 is greater than the predetermined power consumption level, the power consumption of the display apparatus 100 may exceed the predetermined power consumption level.

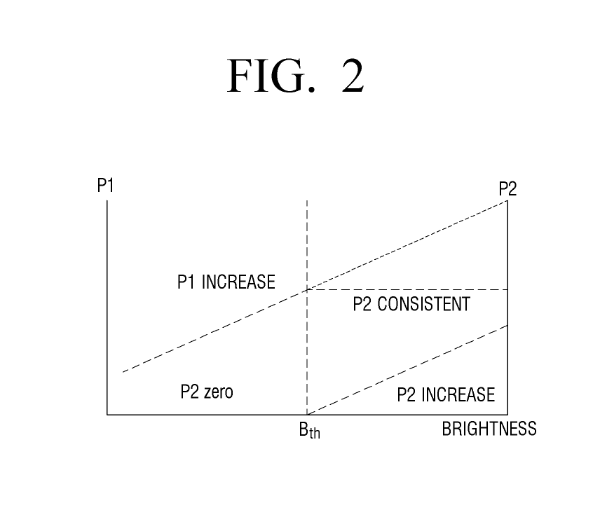

FIG. 2 is a graph explaining how power is supplied to the backlight, according to an exemplary embodiment. With reference to FIG. 2, P1 is power corresponding to the power supplied from the power supply unit 110, P2 is power corresponding to the power supplied by the secondary battery 120, and Bₜₕ is a critical brightness value of the backlight. That is, power is consumed the most in the backlight in the case of LED and LCD TVs, and thus it is possible to know whether or not the power consumption of the display apparatus 100 is greater than the predetermined power consumption level based on the critical brightness value of the backlight.

With reference to the aforementioned table 1, an assumption has been made that the TV is 46 inches and so the control unit 140 has the parameter that the predetermined power consumption should be no more than 93 W, in order to comply with the Energy Star standards of table 1.

In this case, the control unit 140 may control the power supply unit 110 to generate the power corresponding to the predetermined power consumption level of 93 W. Therefore even when the brightness of the backlight is greater than the critical brightness value, the power supply unit 110 does not supply power greater than the predetermined power consumption level of 93 W. That is, when the brightness of the backlight is greater than the critical brightness, P1 is fixed. However, since LED and LCD TVs are not self-light emitting apparatuses, the brightness of the TV is completely determined by the backlight. Therefore, in order to increase the brightness, the power supplied from the backlight driving unit to the backlight must be further increased. That is, more power must be supplied to raise the brightness, in order to raise the brightness of the TV. However, as illustrated above, in the case where the power supply unit 110 generates only the power corresponding to the predetermined power consumption level of 93 W, the power supplied to the backlight cannot exceed the predetermined power consumption level of 93 W, and thus it appears impossible to achieve a brightness which is greater than a certain degree while staying within the standards. Therefore, in the display apparatus 100 according to an exemplary embodiment, when the power consumption of the display apparatus 100 needs to exceed the predetermined power consumption level so as to achieve a desired level of brightness, the control unit 140 controls the backlight driving unit 130 so that the power output from the power supply unit 110 and also the power P2 from the secondary battery 120 are supplied to the backlight. By doing this, when the desired brightness of the backlight is greater than the critical brightness value, the power supply unit 110 supplies a consistent P1, and makes the secondary battery 120 supply the power necessary for a brighter backlight, thereby achieving a brighter TV such that the actual power consumption of the display apparatus 100 does not exceed the predetermined power consumption level according to a desired value such as a value from Table 1.

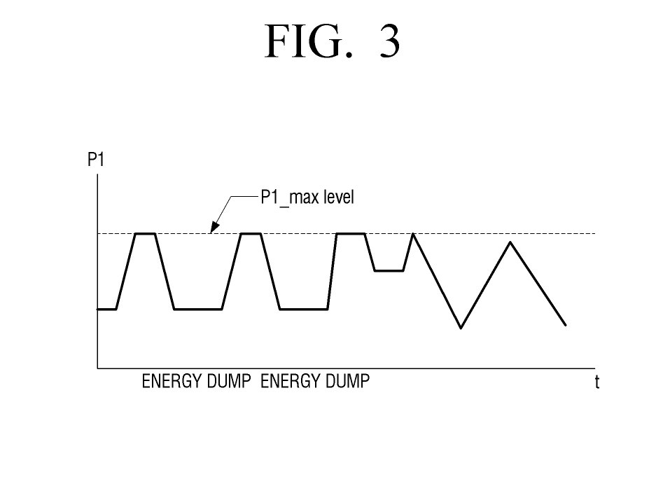

FIG. 3 is a graph for explaining a method for charging the secondary battery with the supplied power. With reference to FIG. 3, P1 refers to the power corresponding to the power generated output from the power supply unit 110.

For example, the control unit 140 may control the power supply unit 110 to continuously supply 93 W which is the predetermined power consumption P1_max level, in which case if the actual power consumption of the display apparatus 100 is less than 93 W, there may be leftover power. That is, in FIG. 3, the difference between the predetermined power consumption P1_max level and the actual power consumption of the display apparatus 100 is the leftover power. In this case, the control unit 110 may carry out control operations so that the secondary battery 120 is charged using the leftover power. By doing this, the secondary battery 120 may be charged with the leftover power, and when the actual power consumption of the display apparatus 100 increases, the control unit 110 may supply the leftover power to the backlight driving unit 130, up to the P1_max level.

FIG. 4 is a block diagram for explaining a power distributing method, and FIG. 5 is a graph for explaining a power distributing method according to FIG. 4. With reference to FIGS. 4 and 5, Zmain is an output impedance of the power supply unit 110, Zboost is an output impedance of the secondary battery 120, I1 is an output current of the power supply unit 110, and I2 is an output current of the secondary battery 120.

Bₜₕ refers to the critical brightness value of the backlight. That is, with LED and LCD TVs, the most power is consumed the most in the backlight, and thus it is possible to know whether or not the power consumption of the display apparatus 100 is greater than the predetermined power consumption level based on the critical brightness of the backlight.

The control unit 140 may control the output impedance of the power supply unit 110 and the secondary battery 120. Specifically, when the brightness of the backlight is smaller than the critical brightness value, in order to raise the brightness of the backlight, the control unit 140 may increase I1 to the backlight driving unit by increasing the output impedance of the power supply unit 110.

However, when the brightness of the backlight is greater than the critical brightness value, the control unit 140 may maintain I1, which is output to the backlight driving unit, at a certain value by controlling the output impedance of the power supply unit 110 to be consistent. By doing this, the control unit 140 may control the power supply unit 110 to supply the power corresponding to the predetermined power consumption level. Therefore, the power supply unit 110 does not supply power which is greater than the predetermined power consumption level even when the brightness of the backlight is greater than the critical brightness value.

However, since LED and LCD TVs are not self light emitting apparatuses, the brightness of the TV is completely determined by the backlight. Therefore, to increase the brightness, the power supplied from the backlight driving unit to the backlight must be increased. That is, more power must be supplied to increase the brightness of the backlight, in order to increase the brightness of the TV. However, as illustrated above, in the case where the power supply unit 110 generates only a level of power corresponding to the predetermined power consumption level, the power supplied to the backlight cannot exceed the predetermined power consumption level, and thus it is apparently impossible to achieve a level of brightness which exceeds a certain degree. Therefore, according to an exemplary embodiment, the control unit 140 controls the output impedance to be a certain value, and increases the output impedance of the secondary battery 120, thereby carrying out a control operation such that the power from the power supply unit 110 and the power P2 discharged from the secondary battery 120 are both supplied to the backlight. By doing this, when the desired level of brightness of the backlight is greater than the critical brightness value, the power supply unit 110 supplies a consistent P1, and makes the secondary battery 120 supply the power necessary for a brighter backlight, thereby embodying a brighter TV without exceeding the predetermined power consumption level.

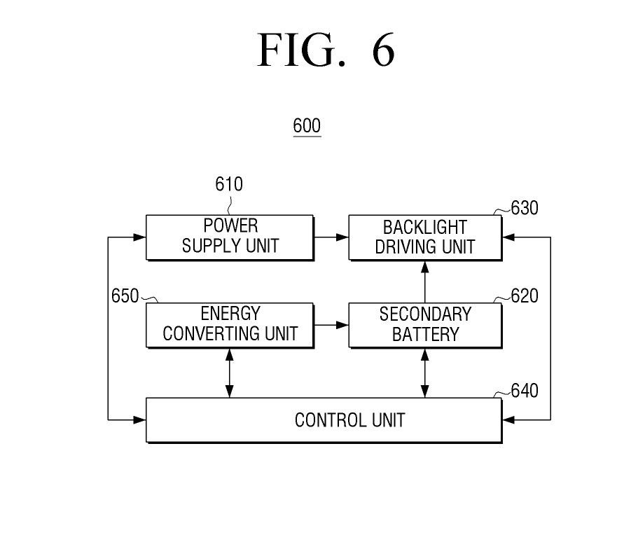

FIG. 6 is a block diagram illustrating a display apparatus according to another exemplary embodiment. With reference to FIG. 6, a display apparatus 600 includes a power supply unit 610, a secondary battery 620, a backlight driving unit 630, a control unit 640, and an energy converting unit 650. Of the elements illustrated in FIG. 6, explanations for elements that overlap those in FIG. 1 have been omitted.

The energy converting unit 650 converts renewable energy into electrical energy.

Herein, the energy source that can be used as renewable energy may be solar power energy generated from indoor light, thermal energy using a thermoelectric element which converts thermal energy generated in TVs into electric energy, and energy generated by collecting the surrounding electromagnetic waves.

In addition, the display apparatus 600 may include an energy converting unit 650 for converting renewable energy into electrical energy outside or inside the display apparatus 600, and the energy converting unit 650 may be separated from the display apparatus 600 and installed outside.

In addition, in the case where the display apparatus 600 has an energy converting unit 650, the control unit 640 may carry out control operations so that the secondary battery 620 is charged with the electric energy output by the energy converting unit 650.

However, the exemplary embodiments are not limited to the ones mentioned above, and thus the display apparatus 600 may be provided without a secondary battery 620, in which case the energy converting unit 650 may be arranged to supply the electrical energy directly to the backlight driving unit 630.

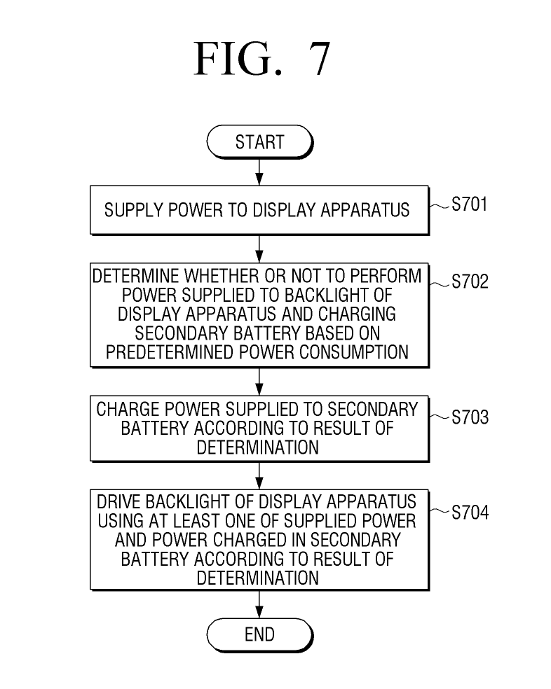

FIG. 7 is a flowchart for explaining a power supply method of a display apparatus according to an exemplary embodiment. With reference to FIG. 7, first of all, power is supplied to the display apparatus S701. Then, it is determined whether or not to supply power to the backlight of the display apparatus and/or to charge the secondary battery, based on the predetermined power consumption level S702. For example, a comparison or determination may be made between the current actual power consumption and the predetermined power consumption level. Then, based on the result of determination, the secondary battery may be charged using the supplied power S703. In addition, based on the result of determination, the backlight of the display apparatus may be driven using the supplied power from the power supply, the power that can be discharged from the secondary battery S704, or both.

Meanwhile, according to various exemplary embodiments, it is possible to provide a display apparatus which provides a brighter screen while complying with a predetermined power consumption level.

In addition, by providing a brighter screen, in case of a 3D TV, it is possible to provide more lively three-dimensional images, thereby contributing to increased user satisfaction.

Although a few exemplary embodiments have been shown and described, it will be appreciated by those skilled in the art that changes may be made to the embodiments without departing from the principles and spirit of the inventive concept, the scope of which is defined in the claims and their equivalents.

What is claimed is:

1. A display apparatus comprising:
a power supply unit which supplies power to the display apparatus;
a secondary battery which is charged using power supplied from the power supply unit;
a backlight driving unit which drives a backlight of the display apparatus using at least one of the power supplied from the power supply unit and power discharged from the secondary battery; and
a control unit which controls the supply of power to the backlight, and controls a charging operation of the secondary battery, based on a predetermined power consumption level.

2. The display apparatus according to claim 1, wherein:
the control unit controls the backlight driving unit so that the power supplied from the power supply unit and the power discharged from the secondary battery are both supplied to the backlight when a present power consumption level of the display apparatus is greater than the predetermined power consumption level; and
the control unit controls the backlight driving unit so that only the power supplied from the power supply unit is supplied to the backlight when the power consumption level of the display apparatus is less than the predetermined power consumption level.

3. The display apparatus according to claim 1, wherein:
the control unit suspends charging the secondary battery when the power consumption level of the display apparatus is greater than the predetermined power consumption level; and
the control unit enables the charging of the secondary battery using the power of the power supply unit when the power consumption of the display apparatus is smaller than the predetermined power consumption.

4. The display apparatus according to claim 3, wherein, when the power consumption level of the display apparatus is less than the predetermined power consumption level, the control unit enables the charging of the secondary battery taking into account a difference between the power consumption level of the display apparatus and the predetermined power consumption level.

5. The display apparatus according to claim 1, wherein:
the control unit detects a charged state of the secondary battery; and
when the control unit detects that the secondary battery is fully charged, the control unit suspends the charging of the secondary battery.

6. The display apparatus according to claim 1, wherein the control unit controls the power supply unit so that the power supply unit supplies power at a level corresponding to the predetermined power consumption level.

7. The display apparatus according to claim 1, wherein the control unit determines the level of the power consumption of the display apparatus based on a brightness of the backlight.

8. The display apparatus according to claim 1, wherein the control unit controls an output impedance of the power supply unit based on a state of the charging operation of the secondary battery and on a state of the driving operation of the backlight.

9. The display apparatus according to claim 1, further comprising an energy converting unit which converts renewable energy into electrical energy; wherein the secondary battery is charged using the converted renewable energy.

10. A power supply method of a display apparatus, the power supply method comprising:
supplying power to the display apparatus;
based on a predetermined power consumption level, making a determination as to a level of power to supply to a backlight of the display apparatus and a level of power to use to charge a secondary battery;
charging the supplied power to the secondary battery according to the result of the determination; and
driving the backlight of the display apparatus using at least one of the supplied power and power discharged from the secondary battery, according to the result of the determination.

11. The power supply method according to claim 10, wherein the driving comprises:
supplying the power from the power supply unit and power discharged from the secondary battery to the backlight when the power consumption level of the display apparatus is greater than the predetermined power consumption level; and
supplying only the power from the power supply unit to the backlight when the power consumption level of the display apparatus is less than the predetermined power consumption level.

12. The power supply method according to claim 10, further comprises:
suspending the charging of the secondary battery when the power consumption level of the display apparatus is greater than the predetermined power consumption level; and
enabling the charging of the secondary battery when the power consumption level of the display apparatus is less than the predetermined power consumption level.

13. The power supply method according to claim 12, wherein, when the power consumption level of the display apparatus is less than the predetermined power consumption level, the charging of the secondary battery is carried out taking into account a difference between the power consumption level of the display apparatus and the predetermined power consumption level.

14. The power supply method according to claim 10, further comprising detecting a charged state of the secondary battery, and
when the detection indicates that the secondary battery is fully charged, suspending the charging of the secondary battery.

15. The power supply method according to claim 10, wherein the supplying of the power to the display apparatus is carried out at a level corresponding to the predetermined power consumption level.

16. The power supply method according to claim 10, further comprising determining the level of the power consumption of the display apparatus based on a brightness of the backlight.

17. The power supply method according to claim 10, further comprising supplying the power to charge the secondary battery by controlling an output impedance, taking into account a state of the charging operation of the secondary battery and a state of the driving of the backlight.

18. The display apparatus according to claim 10, further comprising converting renewable energy into electrical energy, and using the converted renewable energy to charge the secondary battery.

19. A display apparatus, comprising:
a power supply and a secondary battery controlled by a controller;
a backlight connected to receive power from the power supply and the secondary battery;
wherein:
the controller regulates a power consumption level of the display apparatus based on a power consumption level goal;
when a current power consumption level is less than the goal level, the controller enables charging of the secondary battery; and
when a requested power consumption level is not less than the goal level, the controller enables the secondary battery to supply power to the backlight.

20. The display apparatus as set forth in claim 19, wherein the controller suspends charging of the secondary battery in response to an indication that the secondary battery is fully charged.
